(19) United States
(12) Patent Application Publication
(10) Pub. No.: US 2008/0054083 A1
(43) Pub. Date: Mar. 6, 2008

(54) Method of tracking HVAC energy usage in multi-unit buildings

(76) Inventor: Nicholas Thomas Evans, Rockford, MN (US)

Correspondence Address: Nicholas Thomas Evans, 5300 Meadow Lakes Trail, Rockford, MN, 55373, US

(21) Appl. No.: 11/895,154

(22) Filed: Aug. 23, 2007

Related U.S. Application Data
(60) Provisional application No. 60/841,600, filed on Aug. 31, 2006.

(51) Int. Cl. G05B 15/00; F24D 19/10; G06Q 30/00

(52) U.S. Cl. 236/1 B; 700/276; 705/34

(57) ABSTRACT

This system, consisting of a data-logging device and a computer software program, calculates the energy used to heat or cool a leased unit within a multi-unit building, where the building employs a centralized heating or cooling source with a centralized utility meter. This system enables the building manager to track and charge occupants for the cost of heating, cooling or other energy usage. It does this by recording the amount of time that each zone calls for heating, cooling, is turned on, etc. This system allows the administrator to download data into a database where a mathematical calculation quantifies each units energy usage. This enables the property manager to shift the cost of utility to the lessee. This could also decrease the operating expense of an investment property, which would increase the operating income, which in turn would increase the value of the building.

### CROSS REFERENCE TO RELATED APPLICATIONS

This application claims the benefit of provisional patent application Ser. No. 60/841,600 filed on Aug. 31, 2006.

### STATEMENT REGARDING FEDERALLY SPONSORED RESEARCH OR DEVELOPMENT

Not Applicable

### REFERENCE TO MICROFISCHE APPENDIX

Not Applicable

### BACKGROUND OF THE INVENTION

In multi-unit buildings that employ centralized HVAC systems, otherwise known as heating, ventilation and air conditioning systems, there is no current method to accurately track and charge occupants or individual users for their heating, cooling or energy usage without providing dedicated heating and cooling systems for each unit which are connected to a dedicated electric, gas or other fuel utility metering device.

### BRIEF SUMMARY OF THE INVENTION

I have invented a new and useful process to track energy use within buildings or systems with centralized utility metering of heating and cooling systems such as boilers, furnaces or chillers, that distributes heating and or cooling to individually leased units or zones where each unit or piece of equipment has a specific use of the centralized system or a zone control with an individual thermostat or other temperature/humidity control devices designed to maintain a temperature set point.

Only one centralized electric, gas or fuel meter serving the HVAC system for the entire building is required. The system will be named Central-Point Control and use the slogan Energy Use Accountability.

### BRIEF DESCRIPTION OF THE SEVERAL VIEWS OF THE DRAWINGS

These and further features of the present invention will be apparent with reference to the following description and drawings, wherein:

FIG. 1, Sheet 1 shows a configuration where all thermostat wiring terminates at a common area, such as in a boiler room. Here you would typically find the zone valves and their wiring.

FIG. 2, Sheet 2 shows a configuration where all thermostat wiring connects to a zone control module.

FIG. 3, Sheet 3 shows a configuration where existing thermostats or thermostatic valves retrofitted with wireless transmitters are connected directly to the zone valves.

FIG. 4, Sheet 4 shows a flowchart that describes the Central-Point systems sequence of operation.

### DETAILED DESCRIPTION OF THE INVENTION

My invention tracks energy usage for each individual zone or control by recording the amount of time that each zone calls for heating, cooling, is turned on, etc. An example would be a 20-unit apartment building where each apartment unit, or zone, has a thermostat to control temperature independent of the other units. My system records the amount of time that each thermostat is calling for heat or cooling or an “on” state and then allows the administrator to retrieve and download the data into a database where a mathematical calculation quantifies each units energy usage.

The database administrator enters the usage period date and time and the cost per therm or kWh or other energy unit, as specified on the monthly utility bill for the building, into the appropriate field of the computer database. The database imports unit usage data by various means described in the claims and then calculates the quantity of therms or kWh or other energy unit used by each individual unit during a specified usage duration and then multiplies the quantity by the cost per energy unit as specified on the utility bill. The result is a calculation of energy used by each individually leased unit during a utility billing cycle or a specified period.

The following formula is used to calculate energy usage:

Cost per therm×(therms used/sum of time of all units)×the time each unit called for heating or cooling=cost of energy usage per unit.

By recording the time in seconds of energy used by each unit, the system enables building managers to track the cost of energy usage for each leased unit. It also enables multi-unit building managers to convey a charge to the occupant of each unit for the amount of energy that their unit consumed. This feature shifts the accountability of energy usage from the building owner to the tenant or lessee who in turn reduces the amount of energy knowingly wasted by the lessee. The lessee can be charged for the amount of energy their unit used. This enables the property manager, if he chooses, to charge a reduced rent for the unit, increasing marketability while shifting the cost of utility to the lessee. This could also decrease the operating expense of an investment property, which would increase the operating income, which in turn would increase the value of the building.

The database where the data is entered can create a professional appearing invoice that is sent to the lessee for payment. Energy used, cost per energy unit, usage history and other pertinent information will appear on the invoice. Payment for energy used will be sent from the lessee to the building administrator or a payment service provider. If the lessee fails to pay their bill, the building administrator or payment service provider will have the ability to electronically disable the lessees temperature control device until the account becomes current.

The Central-Point Control system utilizes the following components:
Existing Thermostats or added wireless signal transmitters: Wireless transmitters connect into existing thermostats or devices or the existing thermostats themselves transmit “on” time data via wires to a Master Data Logger. New thermostats with built-in wireless transmitters can be provided if desired. All HVAC systems including single to multistage, thermostatic and pneumatic controls can be accommodated.
Master Data Logger: receives signal from existing thermostats or wireless transmitters and stores data for periodic download. Data can be retrieved through a network, a cellular link, a land phone line link, manually through the on-board display or by simply connecting a flash drive or computer into the integrated USB or Serial port.
Computer software database: A computer program automatically retrieves the data and imports it into the pertinent fields which are linked to reports dedicated to each individual unit or sub-system.
Billing data is printed onto optional professional looking, pre-printed color invoices with perforated “return with payment” section and matching envelopes. These are used when billing Tenants or individual users of sub-systems.

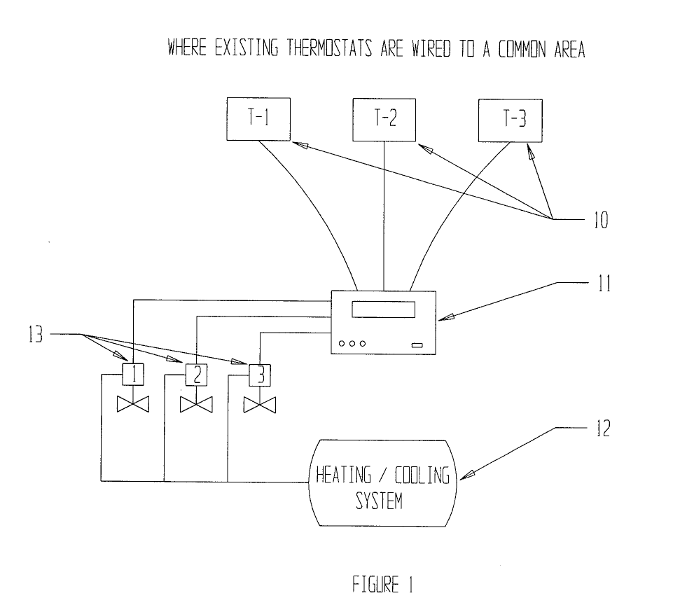

Referring now to the drawing, FIGS. 1-3 show three ways the Central-Point system can be configured.

FIG. 1 shows a configuration where all thermostat wiring terminates at a common area, such as a boiler room. Here you would typically find the zone valves and their wiring; both the existing thermostat(s) 10 and zone valve(s) 13 are wired to addressable terminals on the Master Data Logger 11. Zone valve “on limit switches” are wired directly to the heating/cooling source. The Master Data Logger holds a digital address for each thermostat that differentiates it from the other thermostats. When a thermostat calls for heat or cooling, an embedded program in the Master Data Logger 11 logs the duration in seconds that the thermostat is on. The applicable zone valve opens until it makes an open limit switch, which starts the boiler system. The time data that each thermostat is on is held in the memory of the Master Data Logger and downloaded to the administrators database monthly or as required.

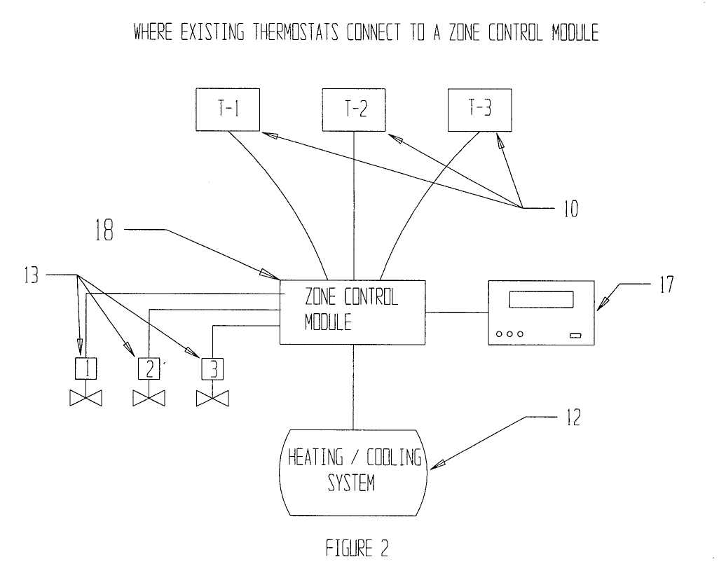

FIG. 2 shows a configuration where all thermostat wiring connects to a zone control module; the existing thermostat(s) 10 are wired to an existing zone control module 18 and the addressable terminals on the Master Data Logger 17. When a thermostat activates heating or cooling, an embedded program in the Master Data Logger 17 logs the duration in seconds that the thermostat is calling for heat or cooling. The zone control module 18 actuates the applicable zone valve as required and operates the heating/cooling system.

### The time on data is held in the memory of the Master Data Logger and downloaded to the administrators database monthly or as required.

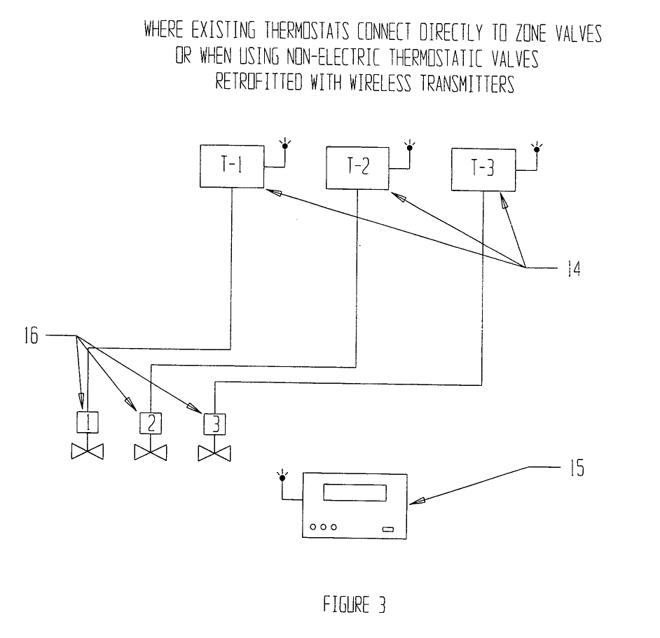

FIG. 3 shows a configuration where existing thermostats or thermostatic valves retrofitted with wireless transmitters are connected directly to the existing zone valves; the existing thermostats 14 are retrofitted with digitally addressable wireless transmitters that send an on signal to the Master Data Logger 15 via radio frequency or other method as defined in the claims. An embedded program in the Master Data Logger 15 logs the duration in seconds that the thermostat is calling for heat or cooling. The time on data is held in the memory of the Master Data Logger and downloaded to the administrators database monthly or as required.

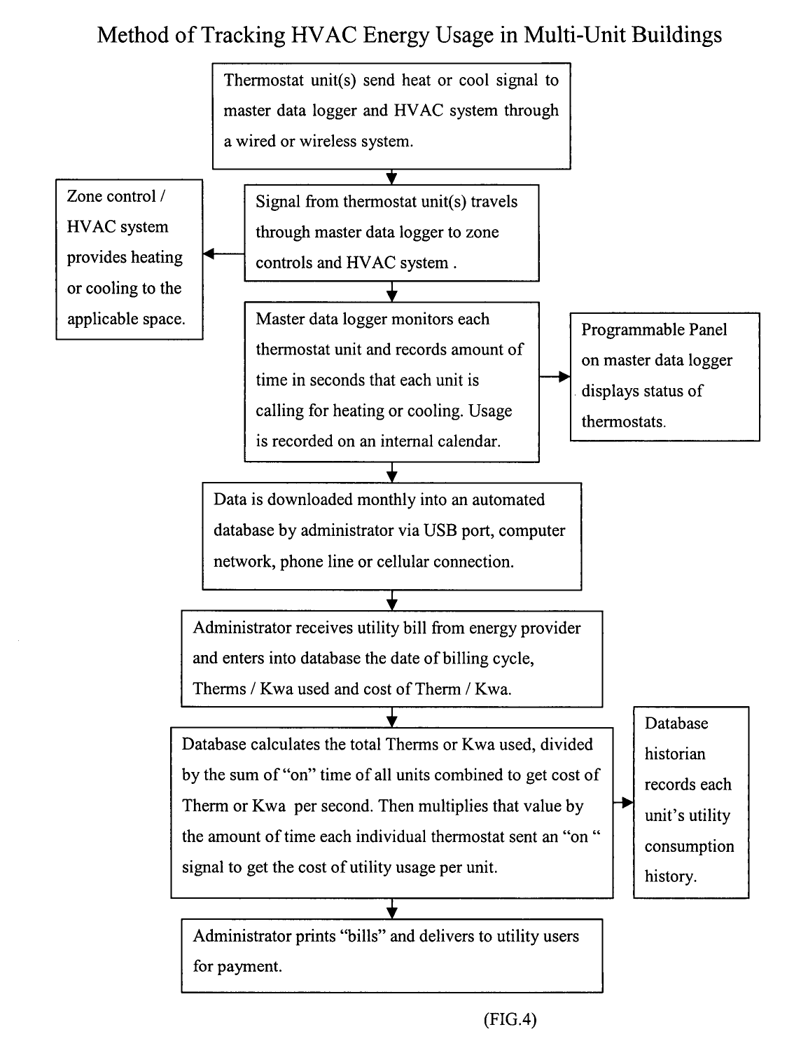

FIG. 4 shows a flowchart that describes the Central-Point systems sequence of operation.

What I claim as my invention is the following:

1. A method and system of monitoring energy consumption of HVAC systems, known as Heating, Ventilation and Air Conditioning systems, which may include humidification or de-humidification, in order to enable a building manager or owner to track or charge Tenants or occupants in multi-unit buildings for the amount of energy their unit used; comprising of:
1a. Connecting a voltage or current transducer to an automatic data-logger or reader to record power outputs from but not limited to thermostatic control devices or other switches.
1b. Collecting data from one or more thermostats, data-loggers or readers into a data collection unit.
1c. Transferring the data from one or more data-loggers or readers to a computer system.
1d. Tracking and billing non-utility metered, individually leased units for their energy usage by metering each of the unit's energy use, using only a centralized utility meter for the building, which measures kWh, therms, or volume.
1e. Using “time” in relation to energy used in order to calculate usage and cost for multi-unit buildings where centralized heating and cooling systems exist.
1f. A program of logging data to be downloaded with the intent to use the information to define an individual units energy usage for a multi unit building that does not have segregated energy metering devices.
1g. A device which wires into or is part or a thermostat or temperature recorder or any other device that records data with the intent to use the data to monitor energy usage and or ultimately charge the user of a leased space for the amount of energy used.
1h. A Master Data Logger which addresses each thermostat and tracks the amount of time each thermostat, data-logger or recorder senses a thermostat or control signal whenever the device is on or calling for heating, cooling, humidification or De-humidification.
1i. Use of the following formula to calculate each individual unit's energy consumption and cost:
Cost of Therm, as shown on bill from utility company,×(Therms used/sum of time of all units)×(the time each unit called for heating or cooling)=cost of energy usage per unit.

2. The method according to claim 1, wherein said monitoring is done manually by hand.

3. The method according to claim 1, wherein said monitoring is done manually using the computer system.

4. The method according to claim 1, wherein said monitoring is done automatically through the computer system.

5. The method, according to claim 1, wherein said period of time is a chronological period of time.

6. The method, according to claim 1, wherein said period of time is a non-chronological period of time.

7. The method according to claim 1, wherein the data obtained from the automatic data-logger or reader is energy consumption data for one or more circuits measured in amperage.

8. The method according to claim 1, wherein the data obtained from the automatic data-logger thermostat or reader is energy consumption data for one or more circuits measured in kilowatt-hours.

9. The method according to claim 1, wherein the data obtained from the automatic data-logger thermostat or reader is energy consumption data for one or more circuits measured in therms.

10. The method according to claim 1, wherein the data obtained from the automatic data-logger thermostat or reader is energy consumption data for one or more circuits measured in volume.

11. The method according to claim 1, wherein the data is transferred from the data-logger thermostat, or reader to the computer memory device via wireless communications.

12. The method according to claim 1 wherein the data is transferred from the data-logger thermostat, or reader to the computer memory device via wired communications.

13. The method according to claim 1, wherein the data is transferred from the data-logger thermostat, or reader to the computer system via wireless communications.

14. The method according to claim 1, wherein the data is transferred from the data-logger thermostat, or reader to the computer system via wired communication.

15. The method according to claim 1, wherein the data is transferred from the data-logger thermostat, or reader to the computer system via a cellular link.

16. The method according to claim 1 wherein the data is transferred from the data-logger, thermostat, or reader to the computer system via a text message.

17. The method according to claim 1 wherein the data is transferred from the data-logger, thermostat, or reader to the computer system via e-mail.

18. The method according to claim 1, wherein the data is transferred from the data-logger thermostat, or reader to the computer system via a phone line.

19. The method according to claim 1, wherein the data is transferred through an X-10 Home Automation system.

20. The method according to claim 1, wherein the data is transferred to a flash drive or other portable memory device through a USB port, which automatically retrieves data from the data-logger or reader.

21. The method according to claim 1, wherein the Master Data Logger or computer system is used to control a security system.

22. The method according to claim 1, wherein the Master Data Logger or computer system is used to control a fire alarm system.

23. The method according to claim 1, wherein the computer system employs the use of Microsoft Excel Spreadsheet.

24. The method according to claim 1, wherein the computer system employs the use of Microsoft Access Database.

25. The method according to claim 1, wherein the computer system employs the use of Microsoft Visual Basic programming.

26. The method according to claim 1, wherein a mathematical sequence is used to define the billing amount.

27. The method according to claim 1, wherein a mathematical sequence is used to define the energy usage.

28. The method according to claim 1, wherein a Microsoft Excel Spreadsheet uses a mathematical sequence to define the billing amount.

29. The method according to claim 1, wherein a Microsoft Access Database uses a mathematical sequence to define the billing amount.

30. The method according to claim 1, wherein Microsoft Visual Basic programming is used to perform a mathematical sequence to define the billing amount.

31. The method according to claim 1, wherein historical trending is used to track variables of energy usage.

32. The method according to claim 1, wherein the title Central-Point Control is used.
